(19) United States
(12) Patent Application Publication
(10) Pub. No.: US 2025/0128600 A1
(43) Pub. Date: Apr. 24, 2025

(54) DISPLAY CONTROL METHOD

(71) Applicant: PANASONIC AUTOMOTIVE SYSTEMS CO., LTD., Kanagawa (JP)

(72) Inventors: Yu KISHIMOTO, Kanagawa (JP); Yohei TANAKA, Kanagawa (JP); Yukimasa KOMIYA, Kanagawa (JP); Tsuyoshi NISHIO, Chiba (JP); Toshihiro MIYAMICHI, Kanagawa (JP)

(73) Assignee: PANASONIC AUTOMOTIVE SYSTEMS CO., LTD., Kanagawa (JP)

(21) Appl. No.: 18/918,865

(22) Filed: Oct. 17, 2024

(30) Foreign Application Priority Data
Oct. 20, 2023 (JP) 2023-181388

(51) Int. Cl. B60K 35/22; G06V 20/58

(52) U.S. Cl. CPC B60K 35/22; G06V 20/58

(57) ABSTRACT

A display control method of gratitude information on a display device is provided. The gratitude information includes at least first gratitude information expressing first gratitude from a first person to a second person, and second gratitude information expressing second gratitude from the second person to a third person. The display control method includes displaying, on the display device, the first person as a first node, the second person as a second node, and the third person as a third node; and on the display device, moving a predetermined display from the first node to the second node, and then moving the predetermined display from the second node to the third node.

### TECHNICAL FIELD

The present disclosure relates to a display control method.

### BACKGROUND ART

A feeling of gratitude arises when people are kind to each other, such as when vehicles yield to each other, when drivers yield to pedestrians near crosswalks, or when people give useful information while traveling. When people feel gratitude, they are inspired to show kindness to others in return. In this way, as gratitude is connected from one person to another, a better society is built.

Patent Literature 1 discloses a service providing method that detects a vehicle condition, obtains a road condition, determines a yielding state based on the detected vehicle condition and the obtained road condition, and provides a service according to the yielding.

### CITATION LIST

### PATENT LITERATURE

Patent Literature 1: JP2004-13656A
Patent Literature 2: JP2019-53624A
Patent Literature 3: JP2016-186767A

### SUMMARY OF INVENTION

By visualizing transmission of gratitude or an intention from one person to another, people can re-recognize acts of kindness received or given, which in turn, motivates further kindness and gratitude towards others.

An object of the present disclosure is to provide a technique of visualizing a connection of gratitude or an intention from one person to another.

A display control method of the present disclosure is a method for controlling gratitude information on a display device. The gratitude information including at least first gratitude information expressing first gratitude from a first person to a second person, and second gratitude information expressing second gratitude from the second person to a third person. The display control method includes displaying, on the display device, the first person as a first node, the second person as a second node, and the third person as a third node; and on the display device, moving a predetermined display from the first node to the second node, and then moving the predetermined display from the second node to the third node.

A display control method of the present disclosure is a method for controlling intention indication information on a display device. The intention indication information including at least first intention indication information expressing a predetermined intention indication from a first person to a second person, and second intention indication information expressing the predetermined intention indication from the second person to a third person. The display control method includes displaying, on the display device, the first person as a first node, the second person as a second node, the third person as a third node; and on the display device, moving a predetermined display from the first node to the second node, and then moving the predetermined display from the second node to the third node.

These comprehensive or specific aspects may be implemented by a system, a device, a method, an integrated circuit, a computer program, or a recording medium, or any combination of the system, the device, the method, the integrated circuit, the computer program, and the recording medium.

According to the present disclosure, a connection of gratitude or an intention from one person to another can be visualized.

### BRIEF DESCRIPTION OF DRAWINGS

FIG. 1 is a schematic diagram illustrating a configuration example of an information processing system according to Embodiment 1;

FIG. 2 is a diagram illustrating a configuration example of a gratitude information DB according to Embodiment 1;

FIG. 3 is a schematic diagram illustrating an example of a gratitude connection video according to Embodiment 1;

FIG. 4 is a flowchart illustrating an example of processing performed by an image capturing device according to Embodiment 1;

FIG. 5 is a flowchart illustrating an example of processing performed by an in-vehicle terminal according to Embodiment 1;

FIG. 6 is a flowchart illustrating an example of processing performed by a user terminal according to Embodiment 1;

FIG. 7 is a flowchart illustrating an example of processing performed by a server device according to Embodiment 1;

FIG. 8 is a diagram illustrating a gratitude information processing method in displaying the gratitude connection video on a personal display device according to Embodiment 1; and

FIG. 9 is a diagram illustrating a gratitude information processing method in displaying the gratitude connection video on a public display device according to Embodiment 1.

### DESCRIPTION OF EMBODIMENTS

Hereinafter, embodiments of the present disclosure will be described in detail with reference to the drawings as appropriate. However, unnecessarily detailed description may be omitted. For example, detailed description of already well-known matters and redundant description of substantially the same configuration may be omitted. This is to avoid unnecessary redundancy of the following description and to facilitate understanding of those skilled in the art. The accompanying drawings and the following description are provided for those skilled in the art to fully understand the present disclosure, and are not intended to limit the subject matter described in the claims.

### Embodiment 1

### System Configuration

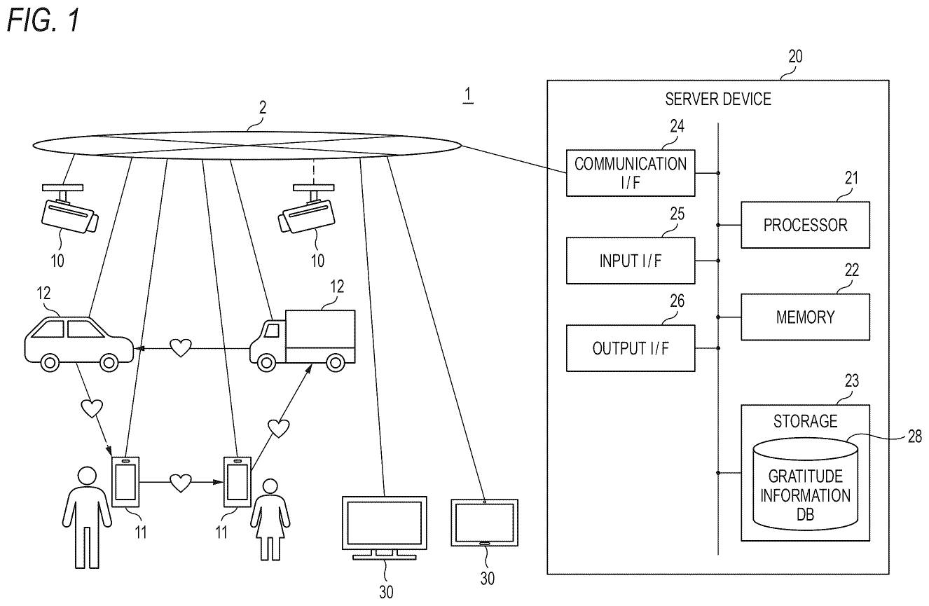

FIG. 1 is a schematic diagram illustrating a configuration example of an information processing system 1 according to Embodiment 1.

The information processing system 1 includes an image capturing device 10, a user terminal 11, an in-vehicle terminal 12, a server device 20, and a display device 30. The server device 20 transmits and receives data to and from the image capturing device 10, the user terminal 11, the in-vehicle terminal 12, and the display device 30 through a communication network 2. Examples of the communication network 2 include the Internet, mobile communication networks (LTE, 4G, 5G, and 6G), virtual private network (VPN), wired LAN, wireless LAN, and Bluetooth (registered trademark).

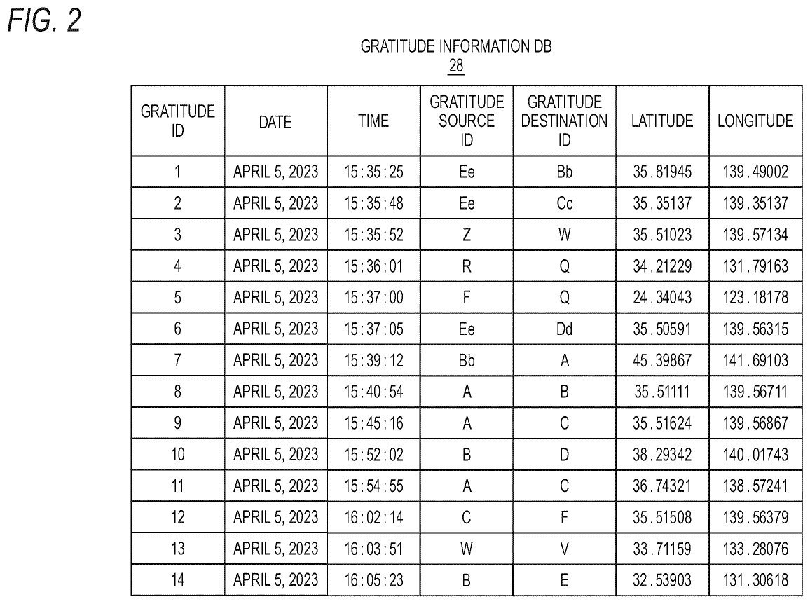

The image capturing device 10 is installed in various places such as a street corner and a building, captures a person, a vehicle, and the like, and generates a captured image. Examples of the image capturing device 10 include a monitoring camera and a live camera. The image capturing device 10 may be an on-board camera installed inside and/or outside a vehicle. The captured image may be a moving image or a still image. The image capturing device 10 analyzes the captured image, and detects that a first person has performed an action expressing gratitude to a second person. The action may be detected using a known technique. In a case in which an action expressing gratitude is detected, the image capturing device 10 generates gratitude information and transmits the gratitude information to the server device 20. Details of the gratitude information will be described later (see FIG. 2).

The user terminal 11 is a terminal carried by a person. Examples of the user terminal 11 include a smartphone, a mobile phone, a tablet terminal, a smartwatch, and smart glasses. The user terminal 11 measures current position information using, for example, a global navigation satellite system (GNSS).

The user terminal 11 generates gratitude information in response to an operation of a person or automatically, and transmits the generated gratitude information to the server device 20. Details of the gratitude information will be described later (see FIG. 2).

The in-vehicle terminal 12 is a terminal installed in a vehicle driven by a person. The vehicle is not limited to an automatic vehicle, and includes a bicycle, a motorcycle, and the like. Examples of the in-vehicle terminal include an IVI device, a car navigation system, and portable navigation. The in-vehicle terminal 12 measures current position information using, for example, GNSS. The in-vehicle terminal 12 generates gratitude information in response to an operation of a person or automatically, and transmits the generated gratitude information to the server device 20. Details of the gratitude information will be described later (see FIG. 2).

### Gratitude Information DB

FIG. 2 is a diagram illustrating a configuration example of a gratitude information DB 28 according to Embodiment 1. As illustrated in FIG. 1, the server device 20 includes the gratitude information DB 28 which manages a plurality of pieces of gratitude information as a database.

The gratitude information includes items such as a gratitude ID, a date, a time, a gratitude source ID, a gratitude destination ID, a latitude, and a longitude.

The gratitude ID is an ID for uniquely identifying the gratitude information.

The date and the time indicate a date and a time at which the gratitude information is generated. Hereinafter, the date and the time are collectively referred to as date and time information.

The gratitude source ID indicates a person ID of a person who expressed the gratitude. The gratitude destination ID indicates a person ID of a person who received the gratitude. The person ID is an ID for uniquely identifying a person, and is given in advance to a person who uses the information processing system 1.

The latitude and longitude indicate a latitude and a longitude of a place where the gratitude information is generated. Hereinafter, the latitude and the longitude are collectively referred to as position information.

The image capturing device 10, the user terminal 11, and the in-vehicle terminal 12 transmit the generated gratitude information to the server device 20. The server device 20 registers, in the gratitude information DB 28, the gratitude information received from each of the image capturing device 10, the user terminal 11, and the in-vehicle terminal 12. Accordingly, the gratitude information related to the gratitude generated in various places is registered in the gratitude information DB 28.

For example, in a case in which, among two vehicles temporarily stopped before entering an intersection, a first vehicle performs an action to encourage a second vehicle to enter the intersection, a driver of the second vehicle performs, on the in-vehicle terminal 12, an operation for expressing gratitude to a driver of the first vehicle (for example, pressing a gratitude button). In this case, the in-vehicle terminal 12 of the second vehicle generates gratitude information in which a date and a time at which the operation for expressing gratitude was performed are set as the date and time information, a person ID of the driver of the second vehicle is set as the gratitude source ID, a person ID of the driver of the first vehicle is set as the gratitude destination ID, and a position where the operation for expressing gratitude was performed is set as the position information, and transmits the generated gratitude information to the server device 20. The server device 20 receives the gratitude information and registers the gratitude information in the gratitude information DB 28. The gratitude source ID may be a person ID set in advance in the in-vehicle terminal 12 of the second vehicle. The gratitude destination ID may be a person ID set in advance in the in-vehicle terminal 12 of the first vehicle, and the in-vehicle terminal 12 of the second vehicle may receive the person ID set in the in-vehicle terminal 12 of the first vehicle.

For example, in a case in which a pedestrian performs an action to encourage a vehicle temporarily stopped before a crosswalk to travel without crossing the crosswalk, a driver of the vehicle performs, on the in-vehicle terminal 12, an operation for expressing gratitude (for example, pressing a gratitude button) to the pedestrian. In this case, the in-vehicle terminal 12 generates gratitude information in which a date and a time at which the operation for expressing gratitude was performed are set as the date and time information, a person ID of the driver of the vehicle is set as the gratitude source ID, a person ID of the pedestrian is set as the gratitude destination ID, and a position where the operation for expressing gratitude was performed is set as the position information, and transmits the generated gratitude information to the server device 20. The server device 20 receives the gratitude information and registers the gratitude information in the gratitude information DB 28. The gratitude source ID may be a person ID set in advance in the in-vehicle terminal 12 of the vehicle. The gratitude destination ID is a person ID set in advance in the user terminal 11 carried by the person who is the pedestrian, and the in-vehicle terminal 12 of the vehicle may receive the person ID set in the user terminal 11 of the pedestrian.

For example, in a case in which a driver of a vehicle temporarily stopped in front of a crosswalk performs an action to encourage a pedestrian temporarily stopped in front of the crosswalk to cross the crosswalk, the pedestrian performs, on the user terminal 11, an operation for expressing gratitude (for example, pressing a gratitude button) to the driver of the vehicle. In this case, the user terminal 11 generates gratitude information in which a date and a time at which the operation for expressing gratitude was performed are set as the date and time information, a person ID of the pedestrian is set as the gratitude source ID, a person ID of the driver of the vehicle is set as the gratitude destination ID, and a position where the operation for expressing gratitude was performed is set as the position information, and transmits the generated gratitude information to the server device 20. The server device 20 receives the gratitude information and registers the gratitude information in the gratitude information DB 28. The gratitude source ID may be a person ID set in advance in the user terminal 11 of the pedestrian. The gratitude destination ID may be a person ID set in advance in the in-vehicle terminal 12 of the vehicle, and the user terminal 11 of the pedestrian may receive the person ID set in the in-vehicle terminal 12 of the vehicle.

For example, in a case in which a first pedestrian receives help from a second pedestrian with carrying baggage, the first pedestrian performs, on the user terminal 11, an operation for expressing gratitude (for example, pressing a gratitude button) to the second pedestrian. In this case, the user terminal 11 generates gratitude information in which a date and a time at which the operation for expressing gratitude was performed are set as the date and time information, a person ID of the first pedestrian is set as the gratitude source ID, a person ID of the second pedestrian is set as the gratitude destination ID, and a position where the operation for expressing gratitude was performed is set as the position information, and transmits the generated gratitude information to the server device 20. The server device 20 receives the gratitude information and registers the gratitude information in the gratitude information DB 28. The gratitude source ID may be a person ID set in advance in the user terminal 11 of the first pedestrian. The gratitude destination ID may be a person ID set in advance in the user terminal 11 of the second pedestrian, and the user terminal 11 of the first pedestrian may receive the person ID set in the user terminal 11 of the second pedestrian.

For example, in a case in which the image capturing device 10 analyzes a captured image and detects that a first person performed an action expressing gratitude to the second person, the image capturing device 10 generates gratitude information in which a date and a time at which the action for expressing gratitude was performed are set as the date and time information, a person ID of the first person is set as the gratitude source ID, a person ID of the second person is set as the gratitude destination ID, and a position where the action for expressing gratitude was performed is set as the position information, and transmits the generated gratitude information to the server device 20. The server device 20 receives the gratitude information and registers the gratitude information in the gratitude information DB 28.

According to the above processing, a large number of pieces of gratitude information that occurred at various dates, times, and positions are registered in the gratitude information DB 28.

The description returns to FIG. 1.

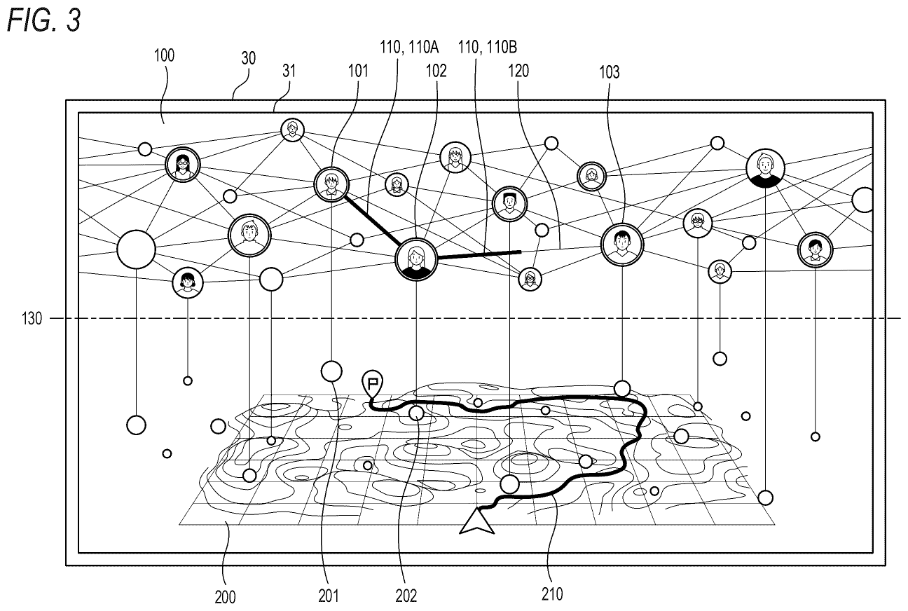

The server device 20 generates gratitude connection information based on the gratitude information registered in the gratitude information DB 28. Further, the server device 20 generates a gratitude connection video 100 by using map information stored in advance and the gratitude connection information, and displays the gratitude connection video 100 on the display device 30. As illustrated in FIG. 3 which will be described later, the display device 30 includes a display area 31 (screen), and displays the gratitude connection video 100 generated by the server device 20.

The server device 20 may include a processor 21, a memory 22, a storage 23, a communication interface (I/F) 24, an input I/F 25, and an output I/F 26. The processor 21 implements functions of the server device 20 described in the present embodiment by cooperating with at least one of the memory 22, the storage 23, the communication I/F 24, the input I/F 25, and the output I/F 26. For example, the processor 21 of the server device 20 implements the functions of the server device 20 described in the present embodiment by executing a computer program stored in the memory 22 or the storage 23. That is, processing performed by the server device 20 in the present embodiment can be read as processing performed by the processor 21. The processor 21 may be read as a central processing unit (CPU), an electronic control unit (ECU), a controller, or the like. The memory 22 is implemented by a volatile storage medium (and/or a non-volatile storage medium). The storage 23 is implemented by a non-volatile storage medium, and is, for example, a flash memory, a solid-state drive (SSD), or a hard disk drive (HDD). The communication I/F 24 is an interface for connecting the server device 20 to the communication network 2. The communication I/F 24 may be any interface for either wired communication or wireless communication. The input I/F 25 is connected with an input device. Examples of the input device include a keyboard, a mouse, a touch panel, a microphone, and a camera. The output I/F 26 is connected with an output device. Examples of the output device include a display, a speaker, and a headphone.

Similarly to the server device 20, the image capturing device 10, the user terminal 11, and the in-vehicle terminal 12 each may include a processor, a memory, a storage, and a communication I/F. Further, the image capturing device 10, the user terminal 11, and the in-vehicle terminal 12 each may also include, in addition to these, a GNSS positioning sensor, a camera, a button, and the like.

### Gratitude Connection Video

FIG. 3 is a schematic diagram illustrating an example of the gratitude connection video 100 according to Embodiment 1. The gratitude connection video 100 represents a gratitude connection between one person and another person as a video.

For example, it is assumed that in the gratitude information DB 28 implemented by the storage 23 of the server device 20, first gratitude information expressing first gratitude from a first person to a second person and second gratitude information expressing second gratitude from the second person to a third person are recorded in advance. In other words, the first gratitude information includes a gratitude source ID that is a person ID of the first person, and a gratitude destination ID that is a person ID of the second person. The second gratitude information includes a gratitude source ID that is the person ID of the second person, and a gratitude destination ID that is a person ID of the third person.

The first gratitude information includes first position information, and the second gratitude information includes second position information. On the display device 30, a position of a first node 101 corresponds to first position information 201. A position of a second node 102 corresponds to second position information 202. The server device 20 displays, on the display device 30, a map image 200 corresponding to the first position information and the second position information. Accordingly, a relation between the node and the position on the map can be visualized. The map image 200 is an image of a map corresponding to an area within a predetermined range including a predetermined place. The predetermined range can be widened or narrowed by a user of the display device 30 or the like.

The first gratitude information may be generated based on an operation resulting from gratitude of the first person. The second gratitude information may be generated based on an operation resulting from gratitude of the second person.

The first gratitude information and/or the second gratitude information may be generated based on image recognition from a captured image captured by the image capturing device 10 (camera). For example, the server device 20 may store in advance a face image of a person who uses the information processing system 1, and may identify the person and specify a person ID by matching the face image with a face image included in the captured image captured by the image capturing device 10 using an image recognition technique.

Further, the first gratitude information and/or the second gratitude information may be based on a detection result of an action expressing gratitude in the captured image captured by the predetermined image capturing device 10 (camera). The action expressing gratitude may be, for example, at least one of a smile in a predetermined direction, a bow in a predetermined direction, a thumbs-up in a predetermined direction, and a hand gesture in a predetermined direction. The predetermined direction may be a direction toward an image capturing device. The image capturing device 10 may be a camera mounted on a vehicle. For example, the server device 20 may perform image recognition of the above action expressing gratitude on the captured image, and generate gratitude information when the action can be recognized. For example, the server device 20 may apply an emotion estimation technique to the captured image, and generate gratitude information when it can be estimated that a person is expressing gratitude.

As illustrated in FIG. 3, the server device 20 displays the first person as the first node 101, the second person as the second node 102, and the third person as a third node 103 on the display device 30. Here, the server device 20 recognizes, from the first gratitude information and the second gratitude information registered in the gratitude information DB 28, that the first person expressed gratitude to the second person, and that the second person expressed gratitude to the third person. Therefore, on the display device 30 (display area 31), the server device 20 moves a moving line 110A from the first node 101 to the second node 102, and then moves a moving line 110B from the second node 102 to the third node 103. Accordingly, the gratitude connection video 100 can visually represent that a chain (circulation) of gratitude is occurring, in which the first person indicated by the first node 101 expresses gratitude to the second person indicated by the second node 102, and the second person indicated by the second node 102, who received the gratitude, in turn, expresses gratitude to the third person indicated by the third node 103.

The server device 20 may move the moving line 110A from the first node 101 to the second node 102, and may start moving the moving line 110B from the second node 102 to the third node within a predetermined time after the moving line 110A arrives at the second node 102. Accordingly, the gratitude connection video can visually represent that a chain (circulation) of gratitude occurred within a specified period, in which the first person indicated by the first node 101 expresses gratitude to the second person indicated by the second node, and the second person indicated by the second node 102, who received the gratitude, in turn, expresses gratitude to the third person indicated by the third node 103.

The first gratitude information includes a first time at which the first gratitude occurred (date and time information), and the second gratitude information includes a second time at which the second gratitude occurred (date and time information). The second time is later than the first time, and the first time and the second time are within a predetermined time difference. Accordingly, gratitude information that is not intended to visualize the chain of gratitude described above can be excluded because a time from occurrence of the first gratitude to occurrence of the second gratitude is too long (for example, several weeks later, several years later).

The server device 20 may start moving the moving line 110A from the first node 101 to the second node 102 on the display device 30 based on a predetermined trigger. Examples of the predetermined trigger include a period of screen update of the display device 30, timing when a new expression of gratitude occurs, and an operation of the user terminal 11.

As illustrated in FIG. 3, on the display device 30, a first icon corresponding to the first person may be displayed at the first node 101, a second icon corresponding to the second person may be displayed at the second node 102, and a third icon corresponding to the third person may be displayed at the third node 103. The first icon may include a first photograph of the first person, the second icon may include a second photograph of the second person, and the third icon may include a third photograph of the third person. Accordingly, the gratitude connection video 100 can visually represent the person indicated by each node.

On the display device 30, an edge line 120 having a predetermined width (second width) in a direction from the first node 101 toward the second node 102 connects the first node 101 and the second node 102. Further, on the display device 30, an edge line 120 having a predetermined width (second width) in a direction from the second node 102 toward the third node 103 connects the second node 102 and the third node 103. Accordingly, the gratitude connection video 100 can visually represent nodes (persons) having a gratitude connection through a connection of the edge lines 120.

On the display device 30, the moving line 110A has a predetermined width (first width) in the direction from the first node 101 toward the second node 102. On the display device 30, the moving line 110B has a predetermined width (first width) in the direction from the second node 102 toward the third node 103. The width (second width) of the edge line 120 is narrower than the width (first width) of the moving line 110. In other words, the width (first width) of the moving line 110 is wider than the width (second width) of the edge line 120. Further, on the display device 30, a color of the edge line 120 and a color of the moving line 110 may be different. Accordingly, the gratitude connection video 100 can represent the edge line 120 and the moving line 110 in a distinguishable manner.

As illustrated in FIG. 3, at least one of the first node 101, the second node 102, and the third node 103 is disposed above a midline 130 of the display device 30 in a vertical direction. At least a portion of the map image 200 is disposed below the midline 130 of the display device 30. The server device 20 maps a position where the first person that is the first node 101 is present or was present in the map image 200 displayed below the midline 130, connects the mapped position and the first node 101 displayed above the midline 130 by a vertical line, and displays the line on the display device 30. The second node 102 and the third node 103 may be displayed in a similar manner. Accordingly, the position where the person corresponding to the node is present or was present can be represented on the map image 200.

Further, the display device 30 may display a route 210 in which a person or a vehicle moved on the map image 200.

### Processing Flow of Image Capturing Device

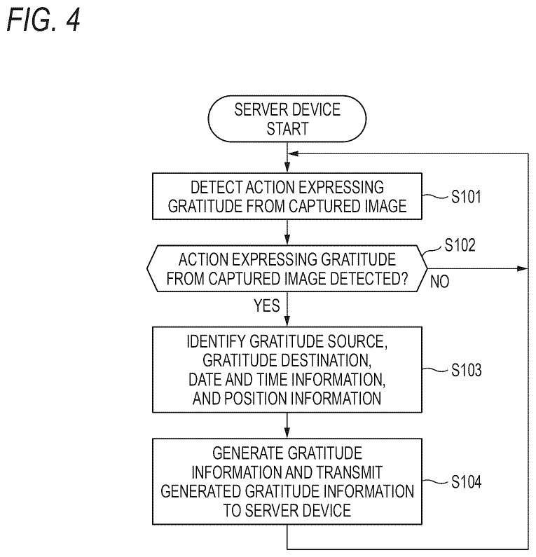

FIG. 4 is a flowchart illustrating an example of processing performed by the image capturing device 10 according to Embodiment 1.

The image capturing device 10 detects an action expressing gratitude from the captured image by, for example, the image recognition technique or the emotion estimation technique (S101).

In step S101, the image capturing device 10 determines whether an action expressing gratitude is detected from the captured image (S102).

If the gratitude action cannot be detected from the captured image (NO in S102), the image capturing device 10 causes the processing to return to step S101.

If the gratitude action can be detected from the captured image (YES in S102), the image capturing device 10 identifies a person who performed the action expressing gratitude (person who is a gratitude source), a person who received the gratitude (person who is a gratitude destination), and a date and time at which and a position where the action expressing gratitude is performed (S103).

Based on identification in step S103, the image capturing device 10 generates gratitude information in which a person ID of the person who is the gratitude source is set as a gratitude source ID, a person ID of the person who is the gratitude destination is set as a gratitude destination ID, a date and time at which the action expressing gratitude was performed is set as date and time information, and a position where the action expressing gratitude was performed is set as position information, and transmits the generated gratitude information to the server device 20 (S104). Then, the image capturing device 10 causes the processing to return to step S101.

### Processing Flow of In-Vehicle Terminal

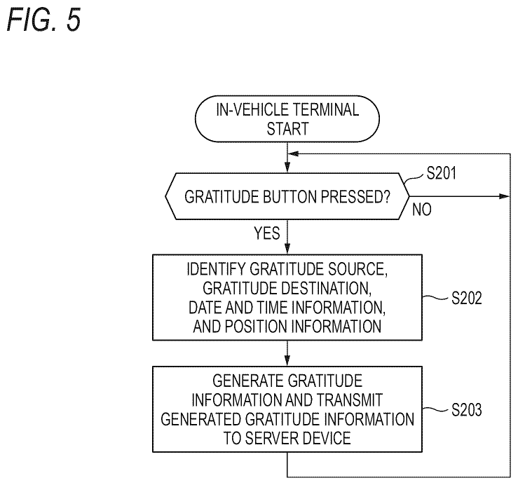

FIG. 5 is a flowchart illustrating an example of processing performed by the in-vehicle terminal 12 according to Embodiment 1.

The in-vehicle terminal 12 determines whether a gratitude button is pressed (S201).

If the gratitude button is not pressed (NO in S201), the in-vehicle terminal 12 causes the processing to return to step S201.

If the gratitude button is pressed (YES in S201), the in-vehicle terminal 12 identifies a person who pressed the gratitude button (person who is a gratitude source), a person who received the gratitude (person who is a gratitude destination), and a date and time at which and a position where the gratitude button is pressed (S202).

Based on identification in step S202, the in-vehicle terminal 12 generates gratitude information in which a person ID of the person who is the gratitude source is set as a gratitude source ID, a person ID of the person who is the gratitude destination is set as a gratitude destination ID, a date and time at which the gratitude button was pressed is set as date and time information, and a position where the gratitude button was pressed is set as position information, and transmits the generated gratitude information to the server device 20 (S203). Then, the in-vehicle terminal 12 causes the processing to return to step S201.

### Processing Flow of User Terminal

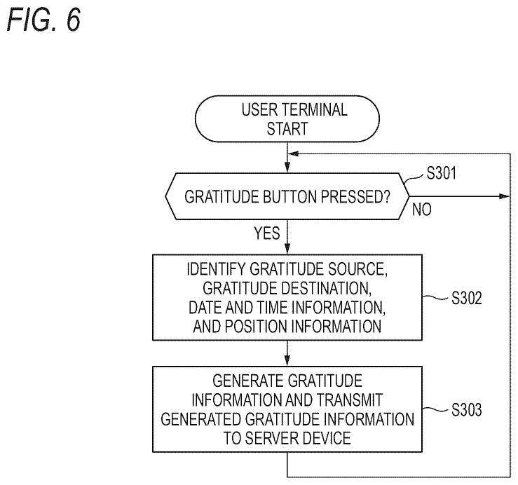

FIG. 6 is a flowchart illustrating an example of processing performed by the user terminal 11 according to Embodiment 1.

The user terminal 11 determines whether a gratitude button is pressed (S301).

If the gratitude button is not pressed (NO in S301), the user terminal 11 causes the processing to return to step S301.

If the gratitude button is pressed (YES in S301), the user terminal 11 identifies a person who pressed the gratitude button (person who is a gratitude source), a person who received the gratitude (person who is a gratitude destination), and a date and time at which and a position where the gratitude button is pressed (S302).

Based on identification in step S302, the user terminal generates gratitude information in which a person ID of the person who is the gratitude source is set as a gratitude source ID, a person ID of the person who is the gratitude destination is set as a gratitude destination ID, a date and time at which the gratitude button was pressed is set as date and time information, and a position where the gratitude button was pressed is set as position information, and transmits the generated gratitude information to the server device 20 (S303). Then, the user terminal 11 causes the processing to return to step S301.

### Processing Flow of Server Device

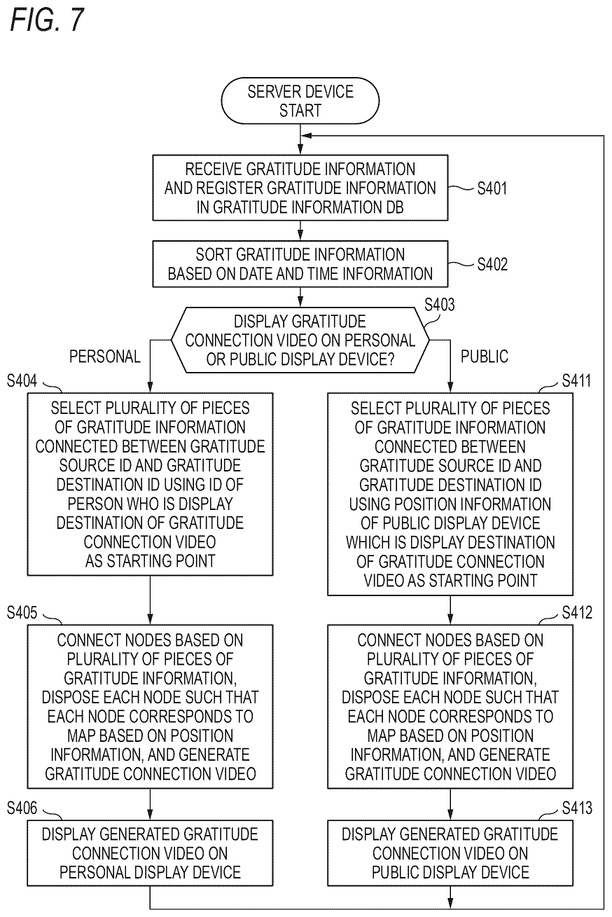

FIG. 7 is a flowchart illustrating an example of processing performed by the server device 20 according to Embodiment 1.

The server device 20 receives the gratitude information from each of the image capturing device 10, the in-vehicle terminal 12, and the user terminal 11, and registers the gratitude information in the gratitude information DB 28 (S401). This processing may be performed every time the gratitude information is received.

The server device 20 acquires a plurality of pieces of gratitude information from the gratitude information DB 28, for example, pieces of gratitude information in which date and time information is within a specified period and/or position information is within a specified range, and sorts the plurality of pieces of gratitude information based on the date and time information (for example, from oldest to newest of date and time) (S402).

The server device 20 determines whether the gratitude connection video 100 is to be displayed on a personal display device 30 or a public display device 30 (S403). The personal display device 30 is, for example, a display device 30 that is viewed by an individual person such as the user terminal 11, the in-vehicle terminal 12, and an individual PC. The public display device 30 is, for example, a display device 30 that can be seen by an unspecified number of persons, such as a display installed in a street corner, a public facility, a highway service area, or the like. The server device 20 may determine that the gratitude connection video 100 is to be displayed on the personal display device 30 when a request for the gratitude connection video 100 is received from the personal display device 30, and may determine that the gratitude connection video 100 is to be displayed on the public display device 30 when a request for the gratitude connection video 100 from the public display device 30.

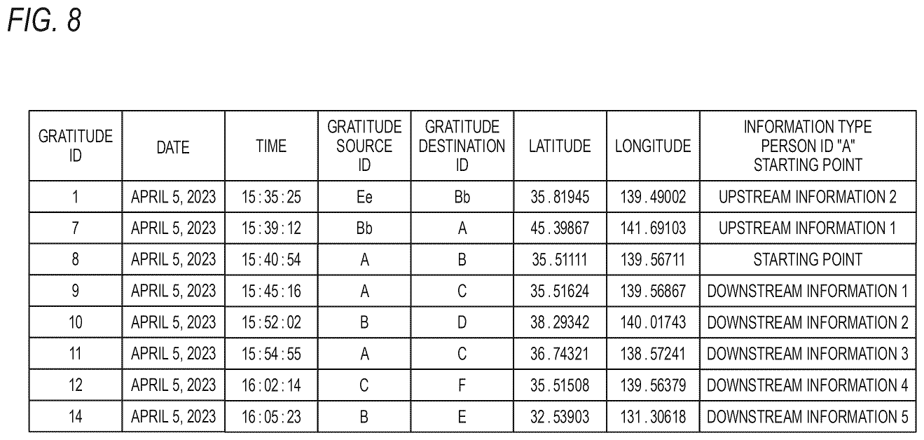

If it is determined that the gratitude connection video 100 is to be displayed on the personal display device 30 (personal in S403), the server device 20 selects, from the plurality of pieces of gratitude information sorted in step S402, a plurality of pieces of gratitude information connected by the gratitude source ID and the gratitude destination ID, using a person ID of a person who is a display destination of the gratitude connection video 100 as a starting point (S404). A specific example of this processing will be described later (see FIG. 8).

The server device 20 connects each node with the edge line 120 based on the gratitude source ID and the gratitude destination ID of the plurality of pieces of gratitude information selected in step S404, disposes each node such that each node corresponds to the map image 200 based on the position information, and generates the gratitude connection video 100 (S405).

The server device 20 displays the gratitude connection video 100 generated in step S405 on the personal display device 30 (S406). Then, the server device 20 causes the processing to return to step S401.

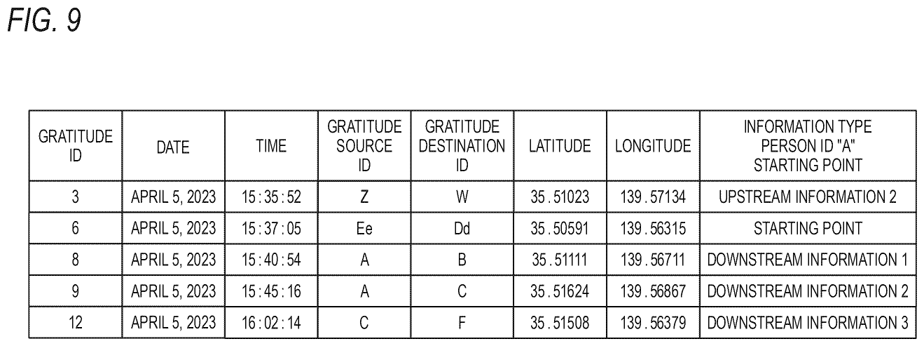

If it is determined that the gratitude connection video 100 is to be displayed on the public display device 30 (public in S403), the server device 20 selects, from the plurality of pieces of gratitude information sorted in step S402, a plurality of pieces of gratitude information in which position information is within a predetermined range, using the position information of the public display device 30 which is a display destination of the gratitude connection video 100 as a starting point (S411). A specific example of this processing will be described later (see FIG. 9).

The server device 20 connects the nodes with the edge line 120 based on the gratitude source ID and the gratitude destination ID of the selected plurality of pieces of gratitude information, disposes the nodes such that each node corresponds to the map image 200 based on the position information, and generates the gratitude connection video 100 (S412).

The server device 20 displays the gratitude connection video 100 generated in step S412 on the public display device 30 (S413). Then, the server device 20 causes the processing to return to step S401.

According to the above processing, the server device 20 can display the gratitude connection video 100 suitable for each of the personal display device 30 and the public display device 30. A personal display method using a personal ID as a starting point, may be displayed for the public or a public display method using position information as a starting point may be displayed for an individual.

### Processing Method in Displaying Gratitude Connection Video on Personal Display Device

FIG. 8 is a diagram illustrating a gratitude information processing method in displaying the gratitude connection video 100 on the personal display device 30 according to Embodiment 1. This processing method corresponds to a specific example of the processing in step S404 illustrated in FIG. 7.

Next, with reference to FIG. 8, a description will be given of a method of selecting a plurality of pieces of gratitude information connected between the gratitude source ID and the gratitude destination ID using a person ID “A” of a person as a starting point.

For example, as illustrated in a third row (gratitude ID “8”) in FIG. 8, the server device 20 selects gratitude information including a gratitude source ID “A” and a gratitude destination ID “B”. Hereinafter, the gratitude information in the selected third line will be referred to as starting point gratitude information.

First, an upstream direction will be described.

As illustrated in a second row (gratitude ID “7”) in FIG. 8, the server device 20 selects gratitude information in which the gratitude source ID “A” of the starting point gratitude information is the gratitude destination ID, in the upstream direction. The selected gratitude information includes a gratitude source ID “Bb” and a gratitude destination ID “A”. Then, as illustrated in a first row in FIG. 8 (the gratitude ID “1”), the server device 20 selects gratitude information in which the gratitude source ID “Bb” is the gratitude destination ID, in the upstream direction.

Next, a downstream direction will be described.

As illustrated in a fifth row in FIG. 8 (the gratitude ID “10”), the server device 20 selects gratitude information in which the gratitude destination ID “B” of the starting point gratitude information is the gratitude source ID, in the downstream direction. The selected gratitude information includes the gratitude source ID “B” and a gratitude destination ID “D”.

By repeating this, the server device 20 can select a plurality of pieces of gratitude information connected by the gratitude source ID and the gratitude destination ID, using the person ID “A” of the person who is the display destination of the gratitude connection video 100 as illustrated in FIG. 8. The server device 20 may sort the plurality of pieces of gratitude information selected in this manner by date and time information.

The server device 20 generates the gratitude connection video 100 by connecting the node of the gratitude source ID and the node of the gratitude destination ID by the edge line 120 based on the plurality of pieces of the gratitude information selected and sorted in this manner. At this time, the gratitude connection video 100 may be generated such that the node of the person ID “A” of the person, which is the starting point, is positioned at a center. Accordingly, a gratitude connection centered on persons can be visualized.

The server device 20 may generate the gratitude connection video 100, which includes an animation that moves such that the moving line 110 flows from a node of a gratitude source ID on an upstream side to a node of a gratitude destination ID on a downstream side, based on the plurality of pieces of gratitude information selected and sorted in this manner. Accordingly, a gratitude chain (circulation) centered on persons can be visualized.

According to the above processing, the server device 20 can generate the gratitude connection video 100 suitable for the personal display device 30 and display the video on the personal display device 30.

### Processing Method in Displaying Gratitude Connection Video on Public Display Device

FIG. 9 is a diagram illustrating a gratitude information processing method in displaying the gratitude connection video 100 on the public display device 30 according to Embodiment 1. This processing method corresponds to a specific example of the processing in step S411 illustrated in FIG. 7.

Next, with reference to FIG. 9, a description will be given of a method of selecting a plurality of pieces of gratitude information using a place at a latitude of “35.50951” and a longitude of “139.56315”, and a vicinity thereof as a starting point position and including position information within a predetermined range therefrom.

For example, as illustrated in a second row (gratitude ID “6”) in FIG. 9, the server device 20 selects gratitude information including the latitude “35.50951” and the longitude “139.56315”, which are a starting point position. Hereinafter, the selected gratitude information will be described as the starting point gratitude information.

First, an upstream direction will be described.

As illustrated in a first row (gratitude ID “3”) in FIG. 9, the server device 20 selects gratitude information in which date and time information is earlier than date and time information of the starting point gratitude information in the upstream direction, from among pieces of gratitude information within a predetermined range from position information of the starting point position.

Next, a downstream direction will be described.

As illustrated in a third row (gratitude ID “8”), a fourth row (gratitude ID “9”), and a fifth row (gratitude ID “12”) in FIG. 9, the server device 20 selects gratitude information in which date and time information is later than date and time information of the starting point gratitude information in the downstream direction, from among the pieces of the gratitude information within the predetermined range from the position information of the starting point position. Then, for those among pieces of gratitude information selected in this manner that are connected by the gratitude source ID and the gratitude destination ID, the server device 20 generates a gratitude connection video 100 by connecting nodes with an edge line 120. At this time, the gratitude connection video 100 may be generated such that the position information of the starting point gratitude information (that is, starting point position) is positioned at a center. Accordingly, a gratitude connection centered on starting point positions can be visualized.

The server device 20 may generate the gratitude connection video 100, which includes an animation that moves such that the moving line 110 flows from a node of a gratitude source ID on an upstream side to a node of a gratitude destination ID on a downstream side, based on the plurality of pieces of gratitude information selected in this manner. Accordingly, a gratitude chain (circulation) centered on starting point positions can be visualized.

According to the above processing, the server device 20 can generate the gratitude connection video 100 suitable for the public display device 30 and display the video on the public display device 30.

### Embodiment 2

In Embodiment 1, as a display control method of gratitude information on the display device 30, a method of displaying the gratitude connection video 100 as illustrated in FIG. 3 is described. In Embodiment 2, a display control method of intention indication information of the display device 30 will be described.

The image capturing device 10, the user terminal 11, the in-vehicle terminal 12, and the server device 20 according to Embodiment 2 may have configurations similar to those of the image capturing device 10, the user terminal 11, the in-vehicle terminal 12, and the server device 20 according to Embodiment 1. Further, in Embodiment 2, the gratitude information in Embodiment 1 is read as intention indication information. The intention indication information is generated when a first person indicates a predetermined intention to a second person, and is transmitted to the server device 20. The predetermined intention includes, in addition to the gratitude described in Embodiment 1, a broader meaning such as praise, support, mutual concessions, and mutual help.

The server device 20 according to Embodiment 2 may display, on the display device 30, an intention connection video (not illustrated) similar to that in FIG. 3, based on the intention indication information.

For example, it is assumed that the intention indication information includes at least first intention indication information expressing a predetermined intention indication from the first person to the second person, and second intention indication information expressing a predetermined intention indication from the second person to a third person. The server device 20 displays, on the display device 30, an intention connection video in which the first person is displayed as a first node, the second person is displayed as a second node, and the third person is displayed as a third node. Further, on the display device 30, in the intention connection video, a predetermined display (for example, moving line 110A) moves from the first node to the second node, and then a predetermined display (for example, moving line 110B) moves from the second node to the third node.

Accordingly, an intention connection video that visualizes an intention connection from one person to another can be displayed on the display device 30. Further, the intention connection video can be represented as an animation in which transmission of an intention from one person to another is performed by movement of a moving line.

### Summary of Present Disclosure

The following techniques are disclosed based on the above description of the present disclosure.

### Technique 1

A display control method of gratitude information on a display device (30) according to the present disclosure, the gratitude information including at least first gratitude information expressing first gratitude from a first person to a second person, and second gratitude information expressing second gratitude from the second person to a third person, the display control method including: displaying, on the display device, the first person as a first node (101), the second person as a second node (102), and the third person as a third node (103); and on the display device, moving a predetermined display (for example, moving line 110A) from the first node to the second node, and then moving the predetermined display (for example, moving line 110B) from the second node to the third node.

Accordingly, the display control method can visualize gratitude connection and gratitude exchange between one person and another.

### Technique 2

The display control method according to technique 1, in which the predetermined display (for example, moving line 110) moves from the first node to the second node, arrives at the second node, and then starts moving from the second node to the third node within a predetermined time.

Accordingly, the display control method can visualize that after a first node expresses gratitude to a second node, the second node expresses gratitude to a third node, that is, a chain of gratitude occurs between the first node, the second node, and the third node.

### Technique 3

The display control method according to technique 1 or 2, in which the first gratitude information includes a first time at which the first gratitude occurred, the second gratitude information includes a second time at which the second gratitude occurred, the second time is later than the first time, and the first time and the second time are within a predetermined time difference.

Accordingly, gratitude information that is not intended to visualize the chain of gratitude described above can be excluded because a time from occurrence of the first gratitude to occurrence of the second gratitude is too long (for example, several weeks later, several years later).

### Technique 4

The display control method according to any one of techniques 1 to 3, in which movement of the predetermined display (for example, moving line 110) from the first node to the second node on the display device is started based on a predetermined trigger.

Accordingly, since movement of a predetermined display (for example, moving line 110) is appropriately started, gratitude exchange between one person and another can be visualized.

### Technique 5

The display control method according to any one of techniques 1 to 4, further including: on the display device, displaying a first icon corresponding to the first person at the first node, displaying a second icon corresponding to the second person at the second node, and displaying a third icon corresponding to the third person at the third node.

Accordingly, a person corresponding to a node can be recognized by viewing an icon corresponding to the node.

### Technique 6

The display control method according to technique 5, in which the first icon includes a first photograph of the first person, the second icon includes a second photograph of the second person, and the third icon includes a third photograph of the third person.

Accordingly, a person corresponding to a node can be recognized by viewing a photograph of the person corresponding to the node.

### Technique 7

The display control method according to any one of techniques 1 to 6, in which on the display device, the predetermined display (for example, moving line 110) has a predetermined width in a direction from the first node toward the second node.

Accordingly, a predetermined display (for example, moving line 110) can be visualized.

### Technique 8

The display control method according to technique 7, in which the predetermined width of the predetermined display is set to a first width, on the display device, a line having a second width in a direction from the first node toward the second node (for example, edge line 120) connects the first node and the second node, and the second width is narrower than the first width.

Accordingly, a predetermined display (for example, moving line 110) and a line (for example, edge line 120) can be distinguished by a difference in line width.

### Technique 9

The display control method according to technique 8, in which on the display device, a color of the line and a color of the predetermined display are different.

Accordingly, a line (for example, edge line 120) and a predetermined display (for example, moving line 110) can be distinguished by a difference in color.

### Technique 10

The display control method according to any one of techniques 1 to 9, further including: recording in advance the first gratitude information and the second gratitude information in a predetermined storage device (for example, storage 23).

Accordingly, processing using first gratitude information and second gratitude information recorded in advance can be performed.

### Technique 11

The display control method according to any one of techniques 1 to 10, in which the first gratitude information is based on an operation resulting from gratitude of the first person (for example, pressing a gratitude button), and/or the second gratitude information is based on an operation resulting from gratitude of the second person (for example, pressing a gratitude button).

Accordingly, it can be detected based on operations that a first person expressed gratitude to a second person and/or that the second person expressed gratitude to a third person.

### Technique 12

The display control method according to any one of techniques 1 to 10, in which the first gratitude information and/or the second gratitude information are based on image recognition from an image captured by a predetermined camera (for example, image capturing device 10).

Accordingly, it can be automatically detected from a captured image that a first person expressed gratitude to a second person and/or that the second person expressed gratitude to a third person.

### Technique 13

The display control method according to any one of techniques 1 to 12, in which, the first gratitude information and/or the second gratitude information are based on a detection result of a predetermined action in the image captured by the predetermined camera.

Accordingly, it can be automatically detected from a captured image that a first person expressed gratitude to a second person and/or that the second person expressed gratitude to a third person.

### Technique 14

The display control method according to technique 13, in which the predetermined action is at least one of a smile in a predetermined direction, a bow in a predetermined direction, a thumbs-up in a predetermined direction, and a hand gesture in a predetermined direction.

Accordingly, it can be automatically detected from a captured image that a first person expressed gratitude to a second person and/or that the second person expressed gratitude to a third person.

### Technique 15

The display control method according to technique 14, in which the predetermined direction is a direction toward the predetermined camera.

Accordingly, it can be automatically detected from a captured image that a first person expressed gratitude to a second person and/or that the second person expressed gratitude to a third person.

### Technique 16

The display control method according to any one of techniques 12 to 15, in which the predetermined camera is a camera mounted on a vehicle.

Accordingly, a driver of a vehicle or a pedestrian present near the vehicle can be captured.

### Technique 17

The display control method according to any one of techniques 1 to 16, in which the first gratitude information includes first position information, and the second gratitude information includes second position information, on the display device, a position of the first node corresponds to the first position information, and a position of the second node corresponds to the second position information.

Accordingly, position information corresponding to a position of a node can be visualized.

### Technique 18

The display control method according to technique 17, further including: displaying, on the display device, a map corresponding to the first position information and the second position information (for example, map image 200).

Accordingly, a map including position information corresponding to a position of a node can be displayed together.

### Technique 19

The display control method according to technique 18, in which at least one of the first node, the second node, and the third node is disposed above a midline of the display device in a vertical direction (for example, midline 130), and at least a portion of the map is disposed below the midline of the display device.

Accordingly, a node connection is displayed on an upper portion of the display device, a map is displayed on a lower portion of the display device, and thus a correspondence relation between a node and position information can be displayed in an easy-to-understand manner.

### Technique 20

A display control method of intention indication information on a display device according to the present disclosure, the intention indication information including at least first intention indication information expressing a predetermined intention indication from a first person to a second person, and second intention indication information expressing the predetermined intention indication from the second person to a third person, the display control method including: displaying, on the display device, the first person as a first node, the second person as a second node, the third person as a third node; and on the display device, moving a predetermined display from the first node to the second node, and then moving the predetermined display from the second node to the third node.

Accordingly, the display control method can visualize a connection of intention indications and an exchange of intention indications between one person and another.

Although the embodiments have been described above with reference to the accompanying drawings, the present disclosure is not limited thereto. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, components in the embodiment described above may be combined freely in a range without departing from the gist of the invention.

### INDUSTRIAL APPLICABILITY

The technique of the present disclosure is useful for a device or a method for visualizing transmission of gratitude or an intention from one person to another.

### CROSS-REFERENCE TO RELATED APPLICATIONS

This application is based on and claims priority under 35 USC 119 from Japanese Patent Application No. 2023-181388 filed on Oct. 20, 2023, the contents of which are incorporated herein by reference.

What is claimed is:

1. A display control method of gratitude information on a display device,
the gratitude information including at least
first gratitude information expressing first gratitude from a first person to a second person, and
second gratitude information expressing second gratitude from the second person to a third person,
the display control method comprising:
displaying, on the display device, the first person as a first node, the second person as a second node, and the third person as a third node; and
on the display device, moving a predetermined display from the first node to the second node, and then moving the predetermined display from the second node to the third node.

2. The display control method according to claim 1, wherein
the predetermined display moves from the first node to the second node, arrives at the second node, and then starts moving from the second node to the third node within a predetermined time.

3. The display control method according to claim 1, wherein
the first gratitude information includes a first time at which the first gratitude occurred,
the second gratitude information includes a second time at which the second gratitude occurred,
the second time is later than the first time, and
the first time and the second time are within a predetermined time difference.

4. The display control method according to claim 1, wherein
movement of the predetermined display from the first node to the second node on the display device is started based on a predetermined trigger.

5. The display control method according to claim 1, further comprising:
on the display device,
displaying a first icon corresponding to the first person at the first node,
displaying a second icon corresponding to the second person at the second node, and
displaying a third icon corresponding to the third person at the third node.

6. The display control method according to claim 5, wherein
the first icon includes a first photograph of the first person,
the second icon includes a second photograph of the second person, and
the third icon includes a third photograph of the third person.

7. The display control method according to claim 1, wherein
on the display device, the predetermined display has a predetermined width in a direction from the first node toward the second node.

8. The display control method according to claim 7, wherein
the predetermined width of the predetermined display is set to a first width,
on the display device, a line having a second width in a direction from the first node toward the second node connects the first node and the second node, and
the second width is narrower than the first width.

9. The display control method according to claim 8, wherein
on the display device, a color of the line and a color of the predetermined display are different.

10. The display control method according to claim 1, further comprising:
recording in advance the first gratitude information and the second gratitude information in a predetermined storage device.

11. The display control method according to claim 10, wherein
the first gratitude information is based on an operation resulting from gratitude of the first person, and/or
the second gratitude information is based on an operation resulting from gratitude of the second person.

12. The display control method according to claim 10, wherein
the first gratitude information and/or the second gratitude information are based on image recognition from an image captured by a predetermined camera.

13. The display control method according to claim 10, wherein
the first gratitude information and/or the second gratitude information are based on a detection result of a predetermined action in the image captured by the predetermined camera.

14. The display control method according to claim 13, wherein
the predetermined action is at least one of
a smile in a predetermined direction,
a bow in a predetermined direction,
a thumbs-up in a predetermined direction, and
a hand gesture in a predetermined direction.

15. The display control method according to claim 14, wherein
the predetermined direction is a direction toward the predetermined camera.

16. The display control method according to claim 12, wherein
the predetermined camera is a camera mounted on a vehicle.

17. The display control method according to claim 1, wherein
the first gratitude information includes first position information, and
the second gratitude information includes second position information,
on the display device,
a position of the first node corresponds to the first position information, and
a position of the second node corresponds to the second position information.

18. The display control method according to claim 17, further comprising:
displaying, on the display device, a map corresponding to the first position information and the second position information.

19. The display control method according to claim 18, wherein
at least one of the first node, the second node, and the third node is disposed above a midline of the display device in a vertical direction, and
at least a portion of the map is disposed below the midline of the display device.

20. A display control method of intention indication information on a display device,
the intention indication information including at least
first intention indication information expressing a predetermined intention indication from a first person to a second person, and
second intention indication information expressing the predetermined intention indication from the second person to a third person,
the display control method comprising:
displaying, on the display device, the first person as a first node, the second person as a second node, the third person as a third node; and
on the display device, moving a predetermined display from the first node to the second node, and then moving the predetermined display from the second node to the third node.
